(19) United States
(12) Patent Application Publication
(10) Pub. No.: US 2026/0061395 A1
(43) Pub. Date: Mar. 5, 2026

(54) SOLID SORBENT DIRECT AIR CAPTURE AND DESORPTION

(71) Applicant: Mosaic Materials, Inc., Alameda, CA (US)

(72) Inventors: Samuel Cheng, Katy, TX (US); Steven Craig Russell, The Woodlands, TX (US); Paul Cody, Houston, TX (US); Dustin Kraft, Houston, TX (US)

(21) Appl. No.: 18/819,566

(22) Filed: Aug. 29, 2024

(51) Int. Cl. B01J 20/34; B01D 53/08; B01J 20/22

(52) U.S. Cl. CPC B01J 20/3441; B01D 53/08; B01J 20/226; B01J 20/3425; B01D 2253/204; B01D 2257/504; B01D 2258/06; B01D 2259/40094

(57) ABSTRACT

A system includes a vessel including an inlet configured to receive a thermal energy source, the vessel connected to a feeder for introducing a solid sorbent to an interior of the vessel and a collector configured to receive the solid sorbent for removal of the solid sorbent from the vessel. The system also includes a heat exchanger disposed within the vessel, the heat exchanger configured to hold the solid sorbent and facilitate a heat exchange process between the solid sorbent and the thermal energy source, and an isolation system configured to isolate the interior of the vessel during introducing the solid sorbent into the vessel and/or during removing the solid sorbent from the vessel.

### BACKGROUND

In the resource recovery and fluid sequestration industries, as well as other industries, sorbents are used to remove gases, vapors, and other components from fluids (e.g., flue gas) via adsorption. For example, adsorption systems such as carbon capture systems may capture carbon dioxide via adsorption with sorbents. The sorbents may then be fed to a desorption system to remove desired components.

### SUMMARY

An embodiment of a system includes a vessel including an inlet configured to receive a thermal energy source, the vessel connected to a feeder for introducing a solid sorbent to an interior of the vessel and a collector configured to receive the solid sorbent for removal of the solid sorbent from the vessel. The system also includes a heat exchanger disposed within the vessel, the heat exchanger configured to hold the solid sorbent and facilitate a heat exchange process between the solid sorbent and the thermal energy source, and an isolation system configured to isolate the interior of the vessel during introducing the solid sorbent into the vessel and/or during removing the solid sorbent from the vessel.

An embodiment of a system includes an adsorption chamber configured to hold a solid sorbent and direct a flow of air through the adsorption chamber to cause adsorption of a material from the air, a transport system configured to transport the solid sorbent from the adsorption chamber to a desorption system, and the desorption system. The desorption system includes a vessel configured to receive the solid sorbent, the desorption system configured to direct thermal energy to an interior of the vessel so that the thermal energy interacts with the solid sorbent and causes desorption of the material from the solid sorbent, and an isolation system configured to isolate the interior of the vessel during introducing the solid sorbent into the vessel and/or during removing the solid sorbent from the vessel.

An embodiment of a method includes introducing a solid sorbent to an interior of a vessel of a desorption system, the vessel including a heat exchanger configured to hold the solid sorbent, the desorption system including an isolation system. The method also includes applying thermal energy to the interior of the vessel to cause a heat exchange process between the solid sorbent and the thermal energy to desorb a material from the solid sorbent, and removing the solid sorbent from the vessel. The isolation system isolates the interior of the vessel during at least one of: introducing the solid sorbent into the vessel, and removing the solid sorbent from the vessel.

### BRIEF DESCRIPTION OF THE DRAWINGS

The following descriptions should not be considered limiting in any way. With reference to the accompanying drawings, like elements are numbered alike:

FIG. 1 schematically depicts an embodiment of a direct air capture system used to remove carbon dioxide from a fluid or gas;

FIG. 2 is a perspective view of an embodiment of a direct air capture system;

FIG. 3 is a perspective view of components of the direct air capture system of FIG. 2;

FIG. 4 is a perspective view of a portion of an adsorption chamber of the system of FIG. 2;

FIGS. 5A and 5B are top views of a portion of embodiments of an adsorption chamber of the system of FIG. 2, and illustrates airflow therethrough;

FIGS. 6A and 6B are perspective views of an embodiment of a direct air capture system;

FIG. 7 schematically depicts an embodiment of a direct air capture system used to remove carbon dioxide from a fluid or gas;

FIG. 8 is a cross-sectional view of an embodiment of a desorption system configured to heat a solid sorbent via a heat exchange fluid;

FIG. 9 is a cross-sectional view of an embodiment of a desorption system configured to heat a solid sorbent via electromagnetic energy;

FIG. 10 is a cross-sectional view of an embodiment of a desorption system configured to heat a solid sorbent via electromagnetic induction or conduction; and

FIGS. 11A-11E depict an example of a process flow for heat exchange and desorption.

### DETAILED DESCRIPTION

A detailed description of one or more embodiments of the disclosed apparatus and method are presented herein by way of exemplification and not limitation with reference to the Figures.

Devices, systems and methods for adsorption, desorption and/or direct air capture are provided herein. Embodiments use a bulk solid sorbent moving bed in a dynamic continuous or batch adsorption and desorption process loop for direct air carbon capture. The solid sorbent may be a metal organic framework (MOF), but may be any other solid sorbent that can be packaged as a granule or pellet (or other suitable configuration), and moved as a bulk solid.

Embodiments of a direct air capture system include at least one adsorption assembly or system that includes an array or plurality of porous flow paths. The flow paths may be defined by one or more porous structures, such as mesh panels. As described herein, a “porous” structure is a structure that does not allow a solid sorbent to pass through, but does allow air and other gases through. The flow paths are defined within a common chamber having an inlet and an exhaust. For example, the adsorption system includes a chamber that houses an array of mesh-lined flow paths in a parallel or non-parallel arrangement; and a common air inlet and exhaust.

Embodiments of the system may include a desorption system for removing captured material. Although embodiments are described as being used to capture and desorb carbon dioxide (CO2) gas, the embodiments may be applicable for capturing and/or desorbing other materials (e.g., water). The desorption system includes at least one desorption chamber, which can accommodate a variety of heat transfer modes. For example, the desorption chamber(s) can operate to desorb material from a sorbent using conduction, convection, microwave (RF), electromagnetic induction or a combination of heat transfer modes.

A problem addressed by the embodiments include the elimination of bulk solid containers and cartridge packaging, which removes the compromises made to satisfy the differing requirements for adsorption and desorption steps.

Advantages presented by the embodiments include the ability to optimize adsorption and desorption independently. De-coupling of adsorption and desorption enables adsorption and desorption systems to be built to differing requirements without consideration to accommodation of cartridges of packaged bulk solid.

Other advantages include lower capital and operating expenditures, a smaller footprint than other DAC systems, higher reliability and plant uptime, and higher purity than other DAC systems. Embodiments may be highly modular and scale-able and provide for high process flexibility (e.g., continuous or batch process where adsorption and desorption timing can be tuned based on process feedback and ambient conditions, accommodation of multiple heating modes (e.g., microwave, conduction, convection, induction, etc.), etc.). Embodiments also include fully enclosed systems that prevent escape of fine sorbent particles, allow for ease of adding or subtracting sorbent without shutdown, dual benefit heat recovery option to reduce energy consumption and cool sorbent to extend life without oxidation, and option to reduce vacuum processes.

Embodiments include a direct air capture system, in which a bulk solid medium moves through a direct air carbon capture process, that includes several stages. The primary stages are adsorption and desorption; although several intermediary conditioning steps may occur between these primary stages. In the adsorption stage, the bulk solid is moved into an adsorption configuration, which may be an array of filter panels in a chamber or chambers (referred to as “adsorption chambers”), whereby air is moved across the bulk solid for the purposes of capturing carbon until a predetermined saturation point. At the predetermined saturation point, the bulk solid is moved from the adsorption stage and into a desorption stage.

A desorption stage may include an optional drying vessel that uses conduction, convection, electromagnetic energy (e.g., microwave energy), induction (or any combination) to remove some of the captured water from the bulk solid. The drying vessel operates at a temperature of, for example, about 50-60 degrees C. Alternatively, the drying stage may be performed without a separate vessel, or as an intermediate stage prior to the desorption stage.

After drying, the bulk solid is moved into a desorption system, which may include a heat exchanger or vessel, where the remaining captured water and CO2 is desorbed from the bulk solid. Desorption may be performed under atmospheric pressure or under a vacuum.

Once a desorption stage is complete, the bulk solid may be moved back into the adsorption stage (as regenerated bulk solid such as MOF) to complete the process loop. An intermediate cooling stage that includes heat recovery may be included in the process. During the process, fines generated may be collected and more bulk solid may be periodically or continuously added to account for any attrition during the process. The process may be continuous or include several discrete batch processes.

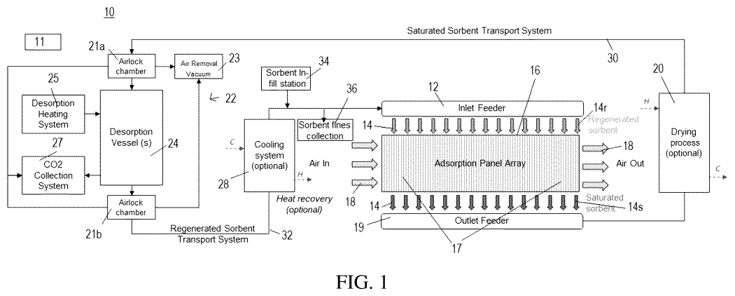

FIGS. 1-8 depict embodiments of a carbon capture system 10 for removing carbon dioxide from air using direct air capture. The system 10 utilizes a solid sorbent that is exposed to air and adsorbs carbon dioxide.

Referring to FIG. 1, in an embodiment, the system 10 is configured as a moving sorbent system in which a solid sorbent 14 moves in a continuous flow or in small discrete batches through the adsorption and desorption processes.

The system 10 includes a feeder 12, such as a hopper or drop spreader, which receives a supply of a solid sorbent 14 that is packaged as a bulk sorbent (e.g., pellets or granules), or otherwise configured so that the solid sorbent 14 can be moved through the system 10. For example, the solid sorbent 14 is a metal organic framework (MOF), but is not so limited. Other examples of solid sorbents include activated carbon and zeolites.

The sorbent may be, for example, metal-organic frameworks, Zeolites, amine-impregnated porous materials, amine-functionalized porous materials, or a combination of one or more of the above. The sorbent may be another sorbent known in the art or a combination of sorbents including those known in the art.

The solid sorbent 14 (e.g., regenerated sorbent 14r) is fed via the feeder 12 to one or more adsorption chambers 16. In this example, an adsorption chamber 16 includes an array of filter panels 17; however, the system 10 may include any adsorption chamber configuration. Air 18 flows through the adsorption chamber 16, where carbon dioxide molecules are adsorbed to the solid sorbent while the solid sorbent is held in the adsorption chamber 16. For example, the solid sorbent is allowed to fall to an outlet feeder 19 and adsorption occurs while the solid sorbent falls, or a batch of the solid sorbent is held in a stationary position during adsorption and is subsequently dropped into the outlet feeder 19. Upon saturation with CO2, saturated sorbent 14s may be transferred to an optional drying process 20 for removal of at least some captured water.

The dried saturated sorbent 14s is then provided to a desorption system 22 for removal of the captured carbon dioxide. The desorption system 22 includes a feeder (not shown), such as a conical hopper, which feeds the saturated dried sorbent 14s to passageways (not shown) within a desorption vessel 24 (or multiple desorption vessels 24). The passageways hold respective portions of the saturated sorbent 14s and may direct the sorbent in a selected direction, such as a vertical direction or direction of gravity. The saturated sorbent 14s is desorbed by applying thermal energy from a heating system 25 to the saturated sorbent 14s, and desorbed carbon dioxide gas may be removed from the vessel 24 to a collection system 27.

In an embodiment, the desorption vessel 24 is connected to one or more airlock assemblies 21. Each airlock assembly 21 is configured to isolate an amount of sorbent (e.g., an amount of the saturated sorbent 14s) during a process in which the amount of sorbent is introduced to the desorption vessel 24, and/or during a process in which the amount of sorbent (e.g., regenerated solid sorbent 14r) is removed from the desorption vessel 24. Each airlock assembly 21 includes an airlock chamber (not shown) defined by chamber walls and a plurality (e.g., a pair) of airlock valves (not shown).

The airlock assemblies are positioned upstream and/or downstream of each vessel 24. In an embodiment, there are airlock to isolate the desorption process from feeding and discharging each vessel 24.

For example, as shown in FIG. 1, two airlock assemblies 21 are connected to the vessel 24, denoted as an input airlock assembly 21a located upstream of the vessel 24, and an output airlock assembly 21b located downstream of the vessel 24. The gas volume within an airlock chamber of a respective assembly can be evacuated to establish a partial vacuum (i.e. a pressure that is less than an atmospheric pressure) via a vacuum pump 23.

The airlock assemblies 21 isolate the main desorption process from feeding and discharging the sorbent into and out of the vessel 24. Both airlock assemblies 21a and 21b are in communication with the collection system 27. The airlock assemblies function to prevent escape of gases (e.g., an injected gas and CO2 or other gas released from the solid sorbent) from the vessel 24 during desorption and prevent air ingress to increase the purity of collected CO2 or other collected gas. The output airlock assembly 21b also increases CO2 production by enabling a vacuum desorption process.

After desorption, regenerated solid sorbent 14r is fed to a conveyor or other mechanism (e.g., tubular conveyor, conveyor belt, bucket elevator conveyor) for return to the feeder 12. The desorption system 22 may include (or may be connected to) a cooling system 28 for recovering waste heat from the desorption process. The waste heat may be used to heat a gas or fluid used for heat exchange via the heating system 25.

The system 10 may include other components, including a transport system 30 for transporting saturated sorbent 14s to the desorption system 22, and a transport system 32 for transporting regenerated sorbent 14r from the desorption system 22 to the inlet feeder 12. Other components may include a sorbent in-fill station 34 for adding lean sorbent to the regenerated sorbent 14r to account for losses due to sorbent attrition into fines (i.e., sorbent particles that are too small to be re-used). A sorbent fines collection station 36 may be included for filtering or removing sorbent fines.

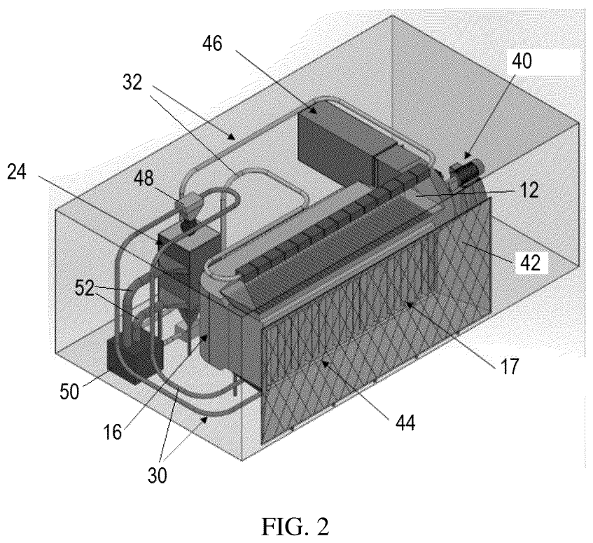

FIG. 2 depicts an example of the direct capture adsorption and desorption system 10 of FIG. 1. Solid sorbent may be moved through the system 10 according to a continuous movement or batch movement process.

In this example, a bulk solid sorbent is fed via the transport system 32 to the feeder 12. The transport system 32 may be a tubular conveyor as shown, but is not so limited and can be any suitable transport system (e.g., bucket elevator). The feeder 12 is configured as a series of discharge valves that are configured to drop solid sorbent (at least substantially evenly) into spaces between the filter panels 17. Other suitable types of feeders may be used.

In semi-continuous or continuous movement, the bulk solid sorbent is gravity fed through the array of filter panels 17, and a blower 40 draws air 18 through an inlet 42 (including an air filter 44) into the chamber 16. CO2 is collected from the blown air via adsorption onto the solid sorbent, and water may also be captured. The air 18 (shown in FIG. 1) passes through the chamber 16 and through the porous panels 17, and is exhausted through an exhaust duct 46. An air filter may be included in the downstream section of the filter panels (not shown). Saturated sorbent at the exit (bottom) of the panel array is conveyed to the desorption vessel 24.

The saturated sorbent is fed into the desorption vessel 24, where the saturated sorbent is heated and CO2 is desorbed, and water may also be desorbed. For example, saturated sorbent is conveyed into a hopper 48 and then gravity fed through the desorption vessel 24.

Thermal energy is applied to heat the saturated sorbent. For example, a closed loop fluid circulation system includes a chamber 50 containing a supply of a heat exchange fluid, such as carbon dioxide (e.g., a CO2 and water vapor mixture desorbed from the sorbent). Fluid conduits or ducts 52 are connected to an interior chamber of the vessel 24 for circulating the heat exchange fluid. Regenerated sorbent may be conveyed back to the adsorption chamber 16 to repeat the cycle of adsorption and desorption. In alternate embodiments, thermal or electromagnetic energy is applied to the sorbent in a vacuum environment without a closed loop fluid circulation system.

Solid sorbent (including new sorbent and regenerated sorbent) may be advanced through the system in a continuous or batch process. In batch movement, MOF (or other solid sorbent) moves through the system 10 in the same manner described above, but using a batch-wise process. The adsorption panel array is split into multiple zones, enabling an exchange of regenerated sorbent from the desorption vessel 24 with saturated sorbent from one or many of the adsorption panel array zones on a regular time basis (or on a variable time basis, varying with respect to the saturation state of the solid sorbent).

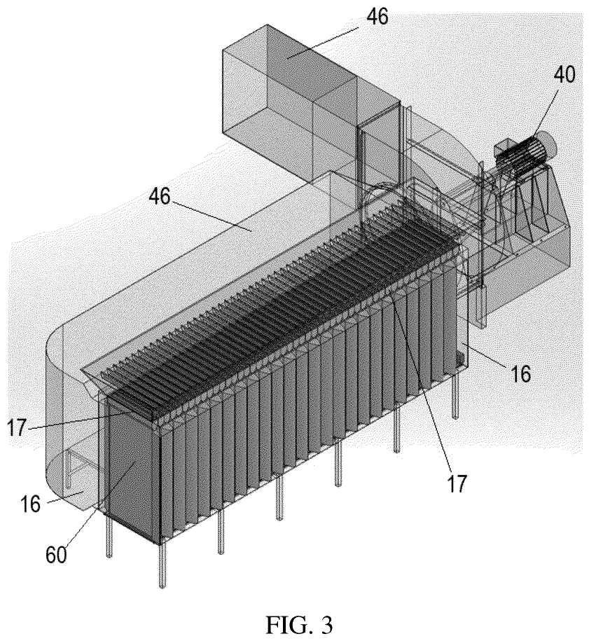

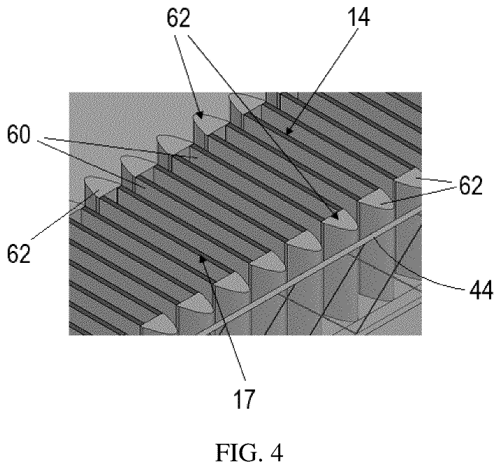

FIGS. 3-5 show details of the adsorption panel array. As shown in FIGS. 3 and 4, each adsorption panel 17 includes opposing porous (e.g., mesh) walls 60 that define an approximately rectangular cavity in which a bed of the solid sorbent 14 is constrained. The panels 17 are arranged in parallel (but are not limited to a parallel arrangement) and define an array of mesh-lined flow paths in parallel (but not limited to a parallel arrangement) and having a common air inlet and exhaust.

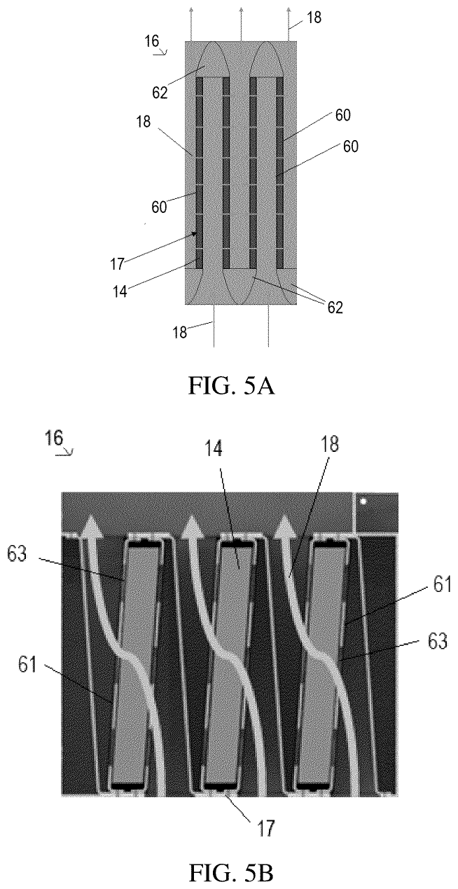

The chamber 16 may include a series of air flow diverter caps 62 to facilitate guiding airflow through the constrained solid sorbent. FIGS. 5A and 5B are top views of embodiments of a portion of the chamber 16, and illustrate airflow through the chamber 16 and the panels 17. As shown in FIG. 5A, atmospheric air 18, which includes CO2, is drawn through the filter 44 (shown in FIG. 4), and air diverter caps 62 force the air 18 to flow through the panels 17. CO2 depleted air is then drawn into the outlet duct 46. Atmospheric air 18 may also include water; the air 18 is drawn through the filter 44, the inlet 42, the air diverter caps 62 and the panels 17, and is exhausted as water depleted air out of duct 46.

FIG. 5B shows an embodiment of the chamber 16, in which the panels 17 direct airflow across the sorbent 14, and include mesh lined flow paths 61. The panels 17 are angled or tilted relative to incoming airflow. As shown, air 18 is forced through an opening or openings 63 on one side of each panel 17 and flow out though an opening or openings 63 on another side of each panel 17.

The adsorption panel array is highly tunable to optimize pressure drop and CO2 uptake efficiency, and is highly modular and scale-able. The adsorption panel array may be much larger than the desorption chamber 24 and may hold more mass of sorbent, because the time required for adsorption may be longer than the time required for desorption.

As noted above, the system 10 may be modular and scalable. For example, multiple adsorption chambers 16 may be connected in the system (in parallel or in series), to increase the adsorption capacity. Likewise, multiple desorption vessels 24 may be connected in series or in parallel. For example, if the system 10 includes multiple chambers 16, each chamber may be in communication with a respective desorption vessel 24.

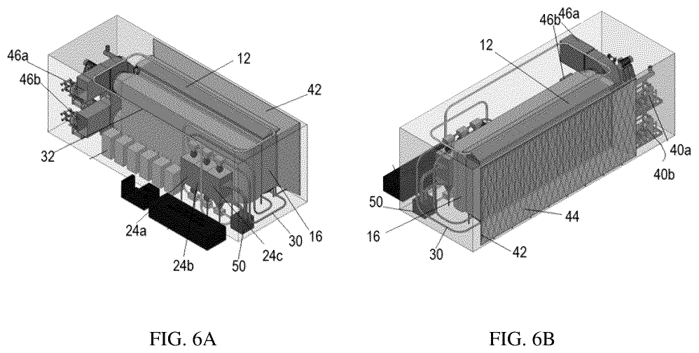

For example, as shown in FIGS. 6A and 6B, the adsorption chamber 16 includes two zones, and each zone is connected to a respective blower 40 (blowers 40a and 40b) and exhaust duct 46 (ducts 46A and 46b). The transport system 30 conveys saturated sorbent to a series of desorption chambers 24 (chambers 24a, 24b and 24c) having a common circulation system. This example has a higher adsorption capacity (e.g., 3,000 metric tons per year (TPY)), as compared to the embodiment of the system shown in FIG. 2 (e.g. 1,000 TPY).

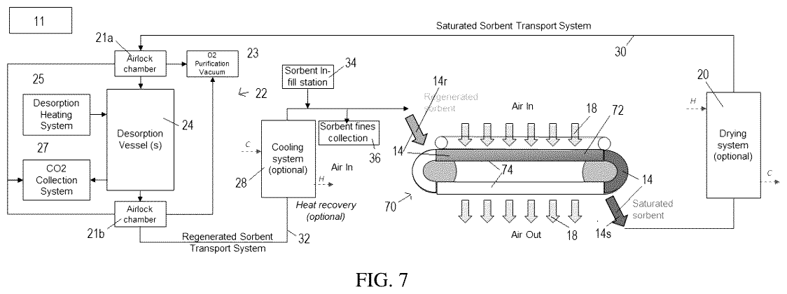

FIG. 7 depicts an example of a carbon capture system 10, in which the adsorption chamber 24 and panels 17 are replaced with a sorbent conveyor 70. The sorbent conveyor 70 moves solid sorbent laterally as air 18 is drawn or blown vertically, although other combinations of directions may be employed. The conveyance speed (e.g., conveyor belt speed) may be variable and can be optimized for exposure length based on environmental conditions.

The conveyor 70 includes one or more sorbent bed containers 72 disposed on or in a conveyor belt 74. Each container 72 has porous (e.g., mesh) walls and can retain a solid sorbent (e.g., as pellets or cartridges). The container(s) 72 hold the solid sorbent in a uniform bed thickness, and the porous walls allow for air to permeate the solid sorbent while maintaining sorbent geometry.

The container(s) 72 may have an open top design, or may be configured to enclose the solid sorbent. For example, each container 72 includes a porous top that may be hinged or removable to allow for opening the container 72 to disposed sorbent therein. In use, for example, solid sorbent is dropped into the container from a suitable feeder at a first end of the conveyor 70, and the sorbent is moved laterally as air is blown vertically through the container 72. When the solid sorbent reaches an opposing end of the conveyor 70, the sorbent is saturated and then drops out into a container or conduit of the transport system 30 for further processing (including desorption).

The system 10 of FIG. 1 and FIG. 7 may be modular and scalable. For example, multiple components or modules (e.g., panel arrays, desorption vessels 24, conveyors, transport systems, etc. may be connected in the system (in parallel or in series), to increase the adsorption and/or desorption capacity. For example, a system having an adsorption capacity (e.g., 1,000 TPY) can be stacked or otherwise be provided with multiple connected modules to achieve a higher adsorption capacity (e.g. 30,000 TPY).

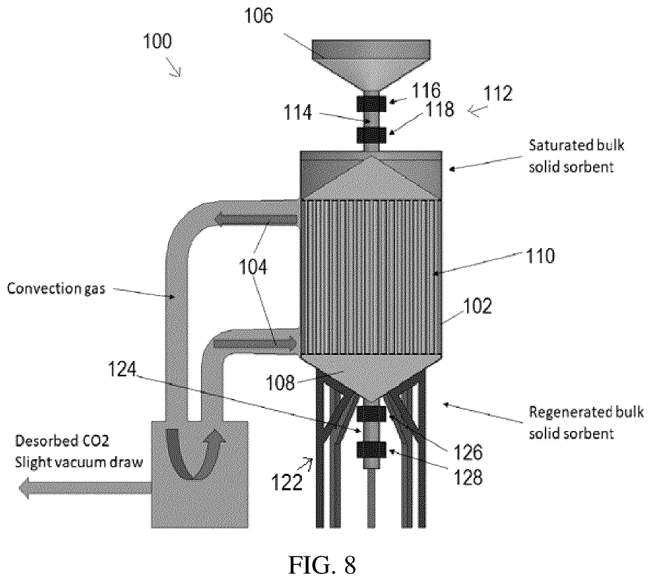

FIGS. 8-10 depict embodiments of a desorption system 100, which may be part of a direct air capture system, such as the system 10. The desorption system includes at least one vessel 102, which may be the vessel 24 of the system 10, but is not so limited and can be used with any material capture system.

The desorption system 100 can use various types of energy to heat solid sorbent (including any combination of types of energy). For example, heat exchange is performed via conduction and convection using a heat exchange fluid, electromagnetic energy (e.g., RF energy such as microwaves), electromagnetic induction or any combination thereof.

In an embodiment, the desorption system 100 includes a vacuum or pressure control system that provides for additional efficiencies. As discussed further herein, an inlet and/or outlet of the vessel 102 includes an airlock that is controlled during the desorption process so that pressure can be continuously controlled and a continuous desorption process through the vessel is maintained. The airlocks (inlet and outlet airlocks) isolate the main desorption process from feeding and discharging the sorbent into and out of the vessel and are in communication with a vacuum pump and the CO2 collection system. Both airlocks function to prevent CO2 escaping from the main vessel and prevent air ingress to increase purity of the collected CO2. The outlet airlock also increases CO2 production by enabling a vacuum desorption process.

FIG. 8 depicts an example in which the desorption system 100 is configured for convective and conduction heating using a heat exchange fluid 104 (e.g., CO2). The vessel 102 includes a sorbent inlet hopper 106 (or other inlet) and a collector 108. The vessel 102 houses a heat exchange assembly or heat exchanger. The heat exchanger includes a plurality of passageways that allow a solid sorbent to move through the vessel 102 (e.g., by gravity), or otherwise retain the solid sorbent. The passageways are made from a thermally conductive material (e.g., aluminum, steel, copper, ceramic, etc.) or other material having varying levels of thermal conductivity (e.g., plastic, ceramic, etc.). The passageways are formed in any of various configurations that allow for heat exchange between the solid sorbent and a fluid that is circulated through the vessel 102. Examples of such configurations include tube-and-shell and plate-and-shell configurations.

For example, the passageways are formed by a plurality of vertically extending tubes 110. Each tube 110 has a size or diameter selected to allow solid sorbent pellets or granules to fall vertically through the heat exchanger to the collector 108. The collector 108 may be connected to a mechanism (e.g., the transport system 32 of FIG. 1) to return the solid sorbent for re-use in carbon capture, or otherwise to transport the solid sorbent to a desired location or system.

Each passageway may be a porous or non-porous passageway. For example, each tube 110 (or other passageway) has a solid cylindrical wall. In another example, the wall is porous, and has a porosity selected so that solid sorbent cannot pass through the wall, but heat exchange fluid can pass through and interact directly with the solid sorbent. The selected porosity also allows desorbed gas to pass through the wall to facilitate removal of the desorbed gas from the vessel 102.

In this example, solid sorbent is introduced and moves downward by gravity toward the collector 108, and the heat exchange fluid 104 (in this example, heated CO2 gas 104 having a temperature greater than a temperature of the solid sorbent) enters the vessel 102 and flows through the vessel 102. Desorbed gases combine into the heat exchange fluid stream and are evacuated through a recirculation loop to equalize system pressure. For example, a slight vacuum is used to draw some of the CO2 gas 104 for collection, sequestration and/or storage. Regenerated sorbent exits the bottom of the collector 108 and may be re-used.

An airlock system includes an inlet airlock 112 that includes an airlock chamber 114, an upper airlock valve 116 and a lower airlock valve 118. An outlet airlock 122 includes an airlock chamber 124, an upper airlock valve 126 and a lower airlock valve 128. It is noted that the airlock system is not limited to having two valves for an airlock chamber. For example, an airlock chamber may have multiple valves connected in series or parallel above and/or below an airlock chamber.

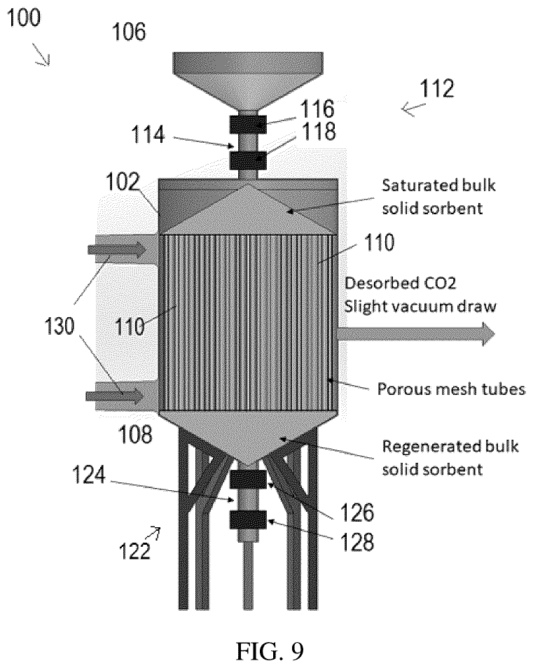

FIG. 9 depicts an example in which the solid sorbent is heated using electromagnetic or RF radiation, such as microwaves. In this example, the vessel 102 includes inlet waveguides (not shown) through which RF energy 130 (or other suitable form of electromagnetic energy 130) is transmitted, and the RF energy may be directed by internal waveguides (not shown) to interact with the solid sorbent. In an embodiment, the vessel 102 is maintained under vacuum (i.e. 3 psi) while the RF energy is transmitted. As the gases are desorbed from the sorbent, they are drawn out of the vessel into a CO2 collection system. In another embodiment, a convection fluid, such as the CO2 gas, may be directed into the vessel 102 for example, to ensure even heat distribution, and optionally to provide additional heat.

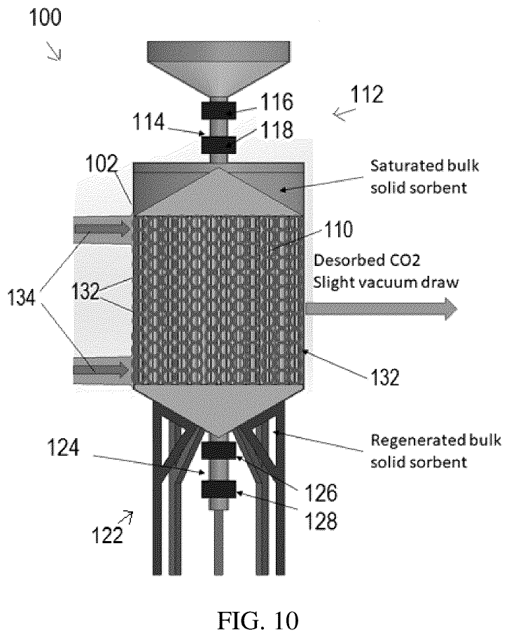

FIG. 10 depicts an example in which the solid sorbent is heated using electromagnetic energy via induction. In this example, the vessel 102 includes a series of induction coils 132 surrounding each tube 110, which are connected to a power source. In use, an alternating current 134 is applied to the induction coils 132 from a power source to heat the tubes 110 and thereby heat the solid sorbent within the tubes 110. The coils shown in FIG. 10 may also be passageways for a heat exchange fluid to circulate through the vessel. In an embodiment, the vessel 102 is maintained under vacuum (i.e., 3 psi). As gases are desorbed from the sorbent, they are drawn out of the vessel 102 into a CO2 collection system. In another embodiment, carbon dioxide gas, or other convection fluid, may be directed into the vessel 102, for example, to ensure even heat distribution, and optionally to provide additional heat.

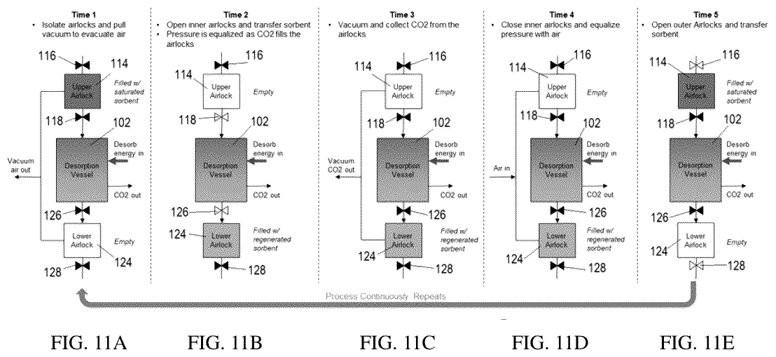

FIGS. 11A-11E describe stages of a desorption process using the vessel 102. The stages represent a cycle of the desorption process, which may be continuously repeated.

At a first stage (FIG. 11A, Time 1), solid sorbent may already be held in the vessel 102. If solid sorbent is in the vessel 102, thermal energy is applied and CO2 is released and removed as discussed above.

Saturated sorbent is added into the inlet airlock chamber 114, and the upper valve 116 is closed. The valves 118, 126 and 128 are all closed, so that the airlocks are isolated. Air is pulled from the inlet and outlet airlock chambers 114 and 124 to create a vacuum therein, such as via the vacuum pump 23 of FIG. 1 or FIG. 7.

In an embodiment, thermal energy may be continuously applied to the desorption vessel throughout the process (i.e., during each stage). In addition, CO2 may be batch-wise or continuously exiting the vessel 102 throughout the process.

At a second stage (FIG. 11B, Time 2), the airlocks are opened to the vessel 102 by opening the lower valve 118 and opening the upper valve 126. Regenerated sorbent falls and fills up the outlet airlock chamber 124, and is replaced by new amount of saturated sorbent. The saturated sorbent in the inlet airlock chamber 114 falls into the vessel 102. Pressure is equalized in the airlocks and the vessel 102 with an inrush of CO2 from the vessel 102.

At a third stage (FIG. 11C, Time 3), the valves 118 and 126 are closed. CO2 is pulled from the airlocks by a vacuum pump or other device or system (e.g., the collection system 27) to collect the CO2 from the previous stage from the airlock chambers 114 and 124, and to collect any additional CO2 that is desorbed from the sorbent in the vacuum environment within the vessel 102.

At a fourth stage (FIG. 11D, Time 4), air is added to equalize the pressure in the airlock chambers 114 and 124. Subsequently, the inlet airlock's upper valve 116 and the outlet airlock's lower valve 128 are opened at a fifth stage (FIG. 11E, Time 5), so that regenerated sorbent is removed and saturated sorbent is added to the inlet airlock chamber 114.

The airlocks may then be isolated as shown in FIG. 11A to repeat the cycle. In the process described above, the airlock chambers surrounded by valves may be replaced by a continuously operating airlock feeder, such as a rotary valve with vent ports located in a body section of the rotary valve and between an inlet and an outlet of the rotary valve.

In an embodiment, the system 10 and/or the desorption system 100 includes a control device or system (referred to as a controller) configured to control operation of one or more components therein. The controller may be configured to perform aspects of a method of carbon capture, desorption and collection as described herein, including one or more stages described in conjunction with FIGS. 11A-11E.

The controller includes one or more processors, and may include components such as an input/output device, and a data storage device (e.g., memory, computer-readable media, etc.) for storing data, models and/or computer programs or software that cause the one or more processors to perform aspects of methods and processes described herein. An example of a controller 11 is shown in FIGS. 1 and 7, which is connected to components such as the desorption system 22 and controls, for example, the airlocks 21. The controller 11 may control any of the components and systems described herein.

Set forth below are some embodiments of the foregoing disclosure:

Embodiment 1: A system, comprising: a vessel including an inlet configured to receive a thermal energy source, the vessel connected to a feeder for introducing a solid sorbent to an interior of the vessel and a collector configured to receive the solid sorbent for removal of the solid sorbent from the vessel; a heat exchanger disposed within the vessel, the heat exchanger configured to hold the solid sorbent and facilitate a heat exchange process between the solid sorbent and the thermal energy source; and an isolation system configured to isolate the interior of the vessel during at least one of: introducing the solid sorbent into the vessel, and removing the solid sorbent from the vessel.

Embodiment 2: The system of any prior embodiment, wherein the isolation system includes an airlock assembly.

Embodiment 3: The system of any prior embodiment, wherein the airlock assembly includes an airlock chamber and a plurality of valves operable to isolate the airlock chamber.

Embodiment 4: The system of any prior embodiment, further comprising a vacuum device configured to remove a gas from the airlock assembly.

Embodiment 5: The system of any prior embodiment, wherein the airlock assembly includes at least one of: an input airlock assembly having an input chamber, a first input airlock valve between the feeder and the input chamber, and a second input airlock valve between the input chamber and the vessel; and an output airlock assembly having an output chamber, a first output airlock valve between the output chamber and the vessel, and a second output airlock valve.

Embodiment 6: The system of any prior embodiment, wherein the second output valve is disposed between the vessel and a transport system for removing the solid sorbent, the transport system being part of a direct air carbon capture system.

Embodiment 7: The system of any prior embodiment, wherein the heat exchange process causes a desorbed material to be removed from the solid sorbent.

Embodiment 8: The system of any prior embodiment, wherein the vessel is part of a direct air carbon capture system configured to adsorb carbon dioxide from air, and the isolation system is configured to prevent escape of desorbed carbon dioxide from the vessel, and prevent air ingress into the vessel during the heat exchange process.

Embodiment 9: The system of any prior embodiment, further comprising a controller configured to operate the isolation system.

Embodiment 10: A system comprising: an adsorption chamber configured to hold a solid sorbent and direct a flow of air through the adsorption chamber to cause adsorption of a material from the air; a transport system configured to transport the solid sorbent from the adsorption chamber to a desorption system; and the desorption system including: a vessel configured to receive the solid sorbent, the desorption system configured to direct thermal energy to an interior of the vessel so that the thermal energy interacts with the solid sorbent and causes desorption of the material from the solid sorbent; and an isolation system configured to isolate the interior of the vessel during at least one of: introducing the solid sorbent into the vessel, and removing the solid sorbent from the vessel.

Embodiment 11: The system of any prior embodiment, wherein the isolation system includes an airlock assembly, the airlock assembly including an airlock chamber and a plurality of valves operable to isolate the airlock chamber.

Embodiment 12: The system of any prior embodiment, further comprising a vacuum device configured to remove a gas from the airlock assembly.

Embodiment 13: The system of any prior embodiment, wherein the airlock assembly includes at least one of: an input airlock assembly having an input chamber, a first input airlock valve between the feeder and the input chamber, and a second input airlock valve between the input chamber and the vessel; and an output airlock assembly having an output chamber, a first output airlock valve between the output chamber and the vessel, and a second output airlock valve, wherein the second output valve is disposed between the vessel and the transport system.

Embodiment 14: A method comprising: introducing a solid sorbent to an interior of a vessel of a desorption system, the vessel including a heat exchanger configured to hold the solid sorbent, the desorption system including an isolation system; applying thermal energy to the interior of the vessel to cause a heat exchange process between the solid sorbent and the thermal energy to desorb a material from the solid sorbent; and removing the solid sorbent from the vessel, wherein the isolation system isolates the interior of the vessel during at least one of: introducing the solid sorbent into the vessel, and removing the solid sorbent from the vessel.

Embodiment 15. The method of any prior embodiment, wherein the isolation system includes an airlock assembly.

Embodiment 16. The method of any prior embodiment, wherein the airlock assembly includes an airlock chamber and a plurality of valves operable to isolate the airlock chamber.

Embodiment 17. The method of any prior embodiment, wherein the airlock assembly includes an input airlock assembly having an input chamber, a first input airlock valve between the feeder and the input chamber, and a second input airlock valve between the input chamber and the vessel.

Embodiment 18. The method of any prior embodiment, wherein the airlock assembly includes an output airlock assembly having an output chamber, a first output airlock valve between the output chamber and the vessel, and a second output airlock valve disposed between the vessel and a transport system for removing the solid sorbent.

Embodiment 19. The method of any prior embodiment, wherein the airlock system, during a desorption process, prevents escape of the desorbed material from the vessel, and prevents air ingress into the vessel.

Embodiment 20: The method of any prior embodiment, wherein introducing the solid sorbent includes: adding the solid sorbent into the input chamber and closing the first input airlock valve; applying a vacuum to the input chamber and the output chamber to at least partially evacuate air; and opening the second input airlock valve to introduce the solid sorbent from the input chamber to the interior of the vessel, and subsequently closing the second input airlock valve to isolate the interior of the vessel during desorption.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally”can include a range of ±8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A system, comprising:
a vessel including an inlet configured to receive a thermal energy source, the vessel connected to a feeder for introducing a solid sorbent to an interior of the vessel and a collector configured to receive the solid sorbent for removal of the solid sorbent from the vessel;
a heat exchanger disposed within the vessel, the heat exchanger configured to hold the solid sorbent and facilitate a heat exchange process between the solid sorbent and the thermal energy source; and
an isolation system configured to isolate the interior of the vessel during at least one of: introducing the solid sorbent into the vessel, and removing the solid sorbent from the vessel.

2. The system of claim 1, wherein the isolation system includes an airlock assembly.

3. The system of claim 2, wherein the airlock assembly includes an airlock chamber and a plurality of valves operable to isolate the airlock chamber.

4. The system of claim 2, further comprising a vacuum device configured to remove a gas from the airlock assembly.

5. The system of claim 2, wherein the airlock assembly includes at least one of:
an input airlock assembly having an input chamber, a first input airlock valve between the feeder and the input chamber, and a second input airlock valve between the input chamber and the vessel; and
an output airlock assembly having an output chamber, a first output airlock valve between the output chamber and the vessel, and a second output airlock valve.

6. The system of claim 5, wherein the second output valve is disposed between the vessel and a transport system for removing the solid sorbent, the transport system being part of a direct air carbon capture system.

7. The system of claim 1, wherein the heat exchange process causes a desorbed material to be removed from the solid sorbent.

8. The system of claim 7, wherein the vessel is part of a direct air carbon capture system configured to adsorb carbon dioxide from air, and the isolation system is configured to prevent escape of desorbed carbon dioxide from the vessel, and prevent air ingress into the vessel during the heat exchange process.

9. The system of claim 1, further comprising a controller configured to operate the isolation system.

10. A system comprising;
an adsorption chamber configured to hold a solid sorbent and direct a flow of air through the adsorption chamber to cause adsorption of a material from the air;
a transport system configured to transport the solid sorbent from the adsorption chamber to a desorption system; and
the desorption system including:
a vessel configured to receive the solid sorbent, the desorption system configured to direct thermal energy to an interior of the vessel so that the thermal energy interacts with the solid sorbent and causes desorption of the material from the solid sorbent; and
an isolation system configured to isolate the interior of the vessel during at least one of: introducing the solid sorbent into the vessel, and removing the solid sorbent from the vessel.

11. The system of claim 10, wherein the isolation system includes an airlock assembly, the airlock assembly including an airlock chamber and a plurality of valves operable to isolate the airlock chamber.

12. The system of claim 11, further comprising a vacuum device configured to remove a gas from the airlock assembly.

13. The system of claim 11, wherein the airlock assembly includes at least one of:
an input airlock assembly having an input chamber, a first input airlock valve between the feeder and the input chamber, and a second input airlock valve between the input chamber and the vessel; and
an output airlock assembly having an output chamber, a first output airlock valve between the output chamber and the vessel, and a second output airlock valve, wherein the second output valve is disposed between the vessel and the transport system.

14. A method comprising:
introducing a solid sorbent to an interior of a vessel of a desorption system, the vessel including a heat exchanger configured to hold the solid sorbent, the desorption system including an isolation system;
applying thermal energy to the interior of the vessel to cause a heat exchange process between the solid sorbent and the thermal energy to desorb a material from the solid sorbent; and
removing the solid sorbent from the vessel, wherein the isolation system isolates the interior of the vessel during at least one of: introducing the solid sorbent into the vessel, and removing the solid sorbent from the vessel.

15. The method of claim 14, wherein the isolation system includes an airlock assembly.

16. The method of claim 15, wherein the airlock assembly includes an airlock chamber and a plurality of valves operable to isolate the airlock chamber.

17. The method of claim 15, wherein the airlock assembly includes an input airlock assembly having an input chamber, a first input airlock valve between the feeder and the input chamber, and a second input airlock valve between the input chamber and the vessel.

18. The method of claim 17, wherein the airlock assembly includes an output airlock assembly having an output chamber, a first output airlock valve between the output chamber and the vessel, and a second output airlock valve disposed between the vessel and a transport system for removing the solid sorbent.

19. The method of claim 15, wherein the airlock system, during a desorption process, prevents escape of the desorbed material from the vessel, and prevents air ingress into the vessel.

20. The method of claim 18, wherein introducing the solid sorbent includes:
adding the solid sorbent into the input chamber and closing the first input airlock valve;
applying a vacuum to the input chamber and the output chamber to at least partially evacuate air; and
opening the second input airlock valve to introduce the solid sorbent from the input chamber to the interior of the vessel, and subsequently closing the second input airlock valve to isolate the interior of the vessel during desorption.
